(19) United States
(12) Patent Application Publication
(10) Pub. No.: US 2026/0038440 A1
(43) Pub. Date: Feb. 5, 2026

(54) DISPLAY DEVICE AND MEMORY ACCESS METHOD THEREOF

(71) Applicant: LG DISPLAY CO., LTD., Seoul (KR)

(72) Inventors: Jae Yong RYU, Paju-si (KR); Yi Rang LIM, Paju-si (KR)

(73) Assignee: LG DISPLAY CO., LTD., Seoul (KR)

(21) Appl. No.: 19/285,663

(22) Filed: Jul. 30, 2025

(30) Foreign Application Priority Data
Aug. 1, 2024 (KR) 10-2024-0102412

(51) Int. Cl. G09G 3/3233; G09G 3/32

(52) U.S. Cl. CPC G09G 3/3233; G09G 3/32; G09G 2300/0842; G09G 2310/08; G09G 2320/0233; G09G 2330/022; G09G 2330/06

(57) ABSTRACT

A display device includes a display panel in which a plurality of data lines and a plurality of pixels are arranged, a source board including a first non-volatile memory and electrically connected to the display panel, and a control board including a timing controller, a second non-volatile memory, and one or more volatile memories and electrically connected to the source board. Memory access methods of a display device are also disclosed.

### CROSS-REFERENCE TO RELATED APPLICATIONS

This application claims priority to and the benefit of Korean Patent Application No. 10-2024-0102412, filed Aug. 1, 2024, the entire contents of which are incorporated herein by reference for all purposes.

### BACKGROUND

### 1. Technical Field

The present disclosure relates to a display device and a memory access method thereof.

### 2. Description of Related Art

A variety of flat panel displays are known, including liquid crystal displays, electroluminescence displays, and the like. The electroluminescence display may display an input image by emitting light by itself without a backlight using light emitting elements arranged in each of its pixels. The light emitting element of the electroluminescence display may be classified into an organic light emitting element and an inorganic light emitting element according to the material of the light emitting layer.

The display device includes a compensation circuit to improve image quality. Each of the pixels of the display panel on which the image is visually reproduced may include light emitting elements and transistors. Due to the variety of manufacturing processes for the display panels, it is difficult to ensure that the characteristics of the light emitting element and the transistor are exactly the same in all pixels. The compensation circuit may compensate for optical and electrical characteristics of pixels using compensation data set for each pixel. The compensation circuit may compensate for deviations in optical and electrical characteristics between pixels to improve the uniformity and image quality of an image reproduced on the display panel. The compensation circuit may be connected to a memory that stores compensation data. Depending on the connection structure between the compensation circuit and the memory, there may be matching constraints between a display panel and a control board, and electromagnetic interference (hereinafter referred to as “EMI”) may occur, which may adversely affect signals transmitted through peripheral wires and peripheral equipment.

The description of related art should not be considered prior art merely because it is mentioned in or associated with this section. The description of related art includes information that describes one or more aspects of the subject technology, and the description in this section does not limit the scope of the invention.

### SUMMARY

An aspect of the present disclosure is to solve the above-described necessity and/or problem.

One or more aspects of the present disclosure provide a display device capable of reducing EMI and a memory access method thereof.

An aspect of the present disclosure is not limited to the above-mentioned problems, and other aspects not mentioned will be clearly understood by those skilled in the art from the following description.

A display device according to an embodiment of the present disclosure includes: a display panel in which a plurality of data lines and a plurality of pixels are arranged; a source board including a first non-volatile memory and electrically connected to the display panel; and a control board including a timing controller, a second non-volatile memory, and one or more volatile memories and electrically connected to the source board.

The timing controller may access the first non-volatile memory during a power-on sequence and a power-off sequence of the display device, and to access the second non-volatile memory during a pixel driving period in which an image is displayed on the display panel.

The display device may further include at least one flexible cable electrically connecting the source board and the control board.

The timing controller may load the data stored in the first non-volatile memory into the volatile memory during the power-on sequence of the display device, and to load the data stored in the volatile memory into the first non-volatile memory during the power-off sequence of the display device.

During the pixel driving period, the timing controller may accumulate pixel data for each sub-pixel, modulates the pixel data using data read from the volatile memory, and to store stress data in which the pixel data is accumulated for each sub-pixel in the second non-volatile memory at predetermined time intervals.

The timing controller may be connected to the first non-volatile memory through first chip enable signal lines and first input/output signal lines, and may be connected to the second non-volatile memory through second chip enable signal lines and second input/output signal lines.

The timing controller may be connected to the first non-volatile memory through first chip enable signal lines and input/output signal lines, and may be connected to the second non-volatile memory through second chip enable signal lines and input/output signal lines.

The timing controller may deactivate the second non-volatile memory during at least a partial time of the power-on sequence and the power-off sequence, and to deactivate the first non-volatile memory during the pixel driving period.

A memory access method of a display device according to an embodiment of the present disclosure includes: loading, in a power-on sequence of the display device, data from the first non-volatile memory into the second non-volatile memory by the timing controller; during a pixel driving period in which an image is displayed on the display panel, loading data stored in the second non-volatile memory into the one or more volatile memories by the timing controller and storing data in which pixel data is accumulated in the second non-volatile memory at predetermined time intervals; and storing, in a power-off sequence of the display device, compensation data stored in the one or more volatile memories and stress data stored in the second non-volatile memory, in the first non-volatile memory by the timing controller.

A memory access method of a display device according to another embodiment of the present disclosure includes: loading, in a first power-on sequence of the display device, data from the first non-volatile memory into the second non-volatile memory by the timing controller; storing, during a first pixel driving period in which an image is displayed on the display panel after the first power-on sequence, stress data in which pixel data is accumulated in the second non-volatile memory at predetermined time intervals; and loading, in a first power-off sequence after the first pixel driving period, data from the one or more volatile memories into the second non-volatile memory by the timing controller.

The memory access method may further include deactivating the first non-volatile memory and activating the second non-volatile memory after the timing controller loads the data from the first non-volatile memory, in the first power-on sequence.

The memory access method may further include loading, in a second power-on sequence of the display device, data from the second non-volatile memory into the one or more volatile memories by the timing controller; storing, during a second pixel driving period after the second power-on sequence, stress data in which pixel data is accumulated in the second non-volatile memory at predetermined time intervals; and loading, in a second power-off sequence after the second pixel driving period, the data from the one or more volatile memories into the second non-volatile memory by the timing controller.

According to one or more aspects of the present disclosure, during a pixel driving period, the electromagnetic interference (EMI) is not generated between a timing controller mounted on a control board and a first non-volatile memory mounted on a source board. During the pixel driving period, the current consumption of the first non-volatile memory is not generated, which allows low power consumption.

According to one or more aspects of the present disclosure, since the initial compensation data is stored in the first non-volatile memory mounted on the source board connected to the display panel, the process of 1:1 matching between the control board and the display panel is not required.

The effects of the present disclosure are not limited to the above-mentioned effects, and other effects that are not mentioned will be apparently understood by those skilled in the art from the following description and the appended claims.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a block diagram illustrating a display device according to one embodiment of the present disclosure;

FIG. 2 is a circuit diagram illustrating a pixel circuit according to one embodiment of the present disclosure;

FIGS. 3A and 3B are diagrams illustrating connection structures of circuit boards of a display device according to one embodiment of the present disclosure;

FIG. 4 is a diagram schematically illustrating a connection structure between a timing controller and first and second non-volatile memories;

FIGS. 5 and 6 are diagrams schematically illustrating connection structures between a timing controller and first and second non-volatile memories when a non-volatile memory is an SLC type NAND flash memory;

FIG. 7 is a flowchart illustrating a memory access method according to a first embodiment of the present disclosure;

FIG. 8 is a flowchart illustrating a memory access method according to a second embodiment of the present disclosure;

FIG. 9 is a flowchart illustrating a memory access method according to a third embodiment of the present disclosure; and

FIGS. 10A and 10B are flowcharts illustrating a memory access method according to a fourth embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “containing” used herein are generally intended to allow other components to be added unless the terms are used with the term “only.” Any references to singular may include plural unless expressly stated otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The expression of a first element, a second elements “and/or” a third element should be understood as any one of the first, second and third elements or as any or all combinations of the first, second and third elements. Similar interpretations apply to the use of “and/or” with two elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

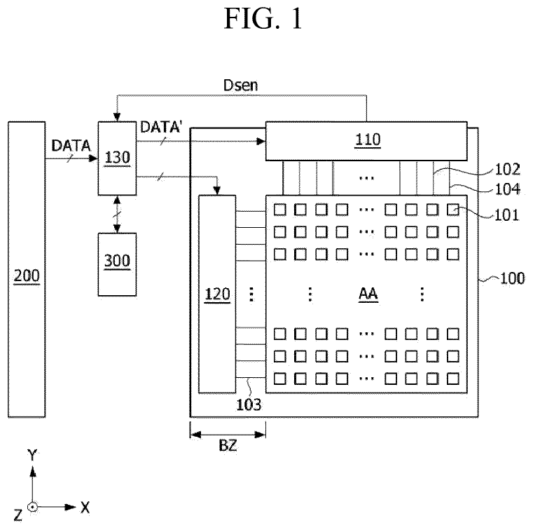

FIG. 1 is a block diagram illustrating a display device according to one embodiment of the present disclosure.

Referring to FIG. 1, the display device according to an embodiment of the present disclosure includes a display panel 100 and a display panel driving circuit for writing pixel data to pixels of the display panel 100.

The display panel 100 may be a panel having a rectangular structure with a length in the X-axis direction, a width in the Y-axis direction, and a thickness in the Z-axis direction. A display area AA of the display panel 100 includes a pixel array for displaying an input image thereon. The pixel array includes a plurality of data lines 102, a plurality of gate lines 103 intersected with the data lines 102, a plurality of sensing lines 104, and pixels arranged in a matrix form. The display panel 100 may further include power lines commonly connected to the pixels. The power lines may be commonly connected to pixel circuits and supply a voltage required for driving pixels 101 to the pixels 101.

The data lines 102 are arranged in the form of long wires along the Y-axis direction of the display panel 100 and are electrically connected to data channel terminals of a data driver 110. The sensing lines 104 are arranged on the display panel in parallel with data lines 102 and may be connected to sub-pixels and to sensing channel terminals of the data driver 110. The gate lines 103 are arranged in the form of long wires along the X-axis direction of the display panel 100 to intersect the data lines 102 and are electrically connected to output terminals of a gate driver 120.

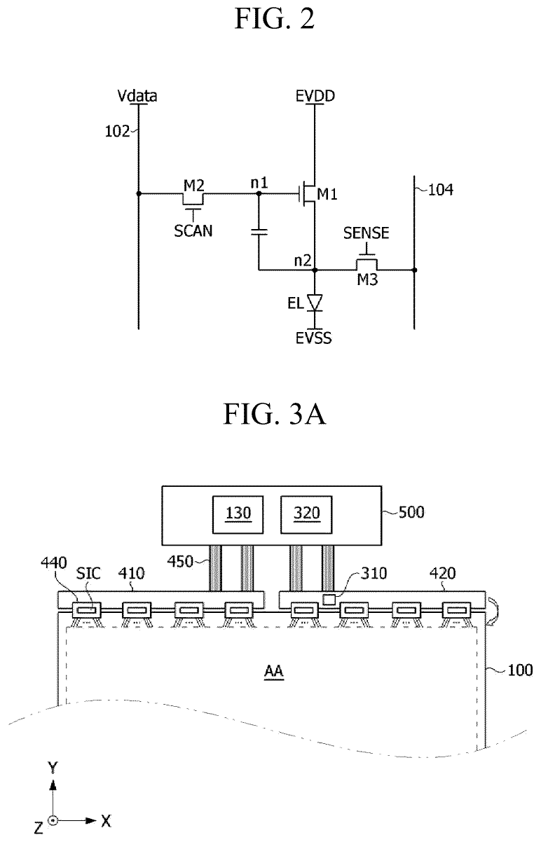

Each of the pixels 101 may be divided into a red sub-pixel, a green sub-pixel, and a blue sub-pixel for color implementation. Each of the pixels may further include a white sub-pixel. Each of the sub-pixels includes a pixel circuit for driving a light emitting element. Each of the pixel circuits is connected to the data lines, the gate lines, and the power lines. The pixel circuits may be implemented as a circuit shown in FIG. 2, but is not limited thereto.

The display panel driving circuit writes the pixel data of the input image to the pixels of the display panel 100 under the control of a timing controller 130. The display panel driving circuit includes a data driver 110 and the gate driver 120.

The display panel driving circuit may further include a touch sensor driver for driving touch sensors. The touch sensor driver is omitted from FIG. 1. The data driver 110 and the touch sensor driver may be integrated into one drive integrated circuit (IC).

The data driver 110 receives the pixel data of the input image received as a digital signal from the timing controller 130 and outputs the data voltage. The data driver 110 includes data channels electrically connected to the data lines 102 to output a data voltage of the input image, and sensing channels connected to the sensing lines 104.

The data channels of the data driver 110 convert pixel data DATA′ of the input image into a gamma compensated voltage using a digital-to-analog converter (hereinafter referred to as a “DAC”) and output a data voltage of the pixel data. The gamma reference voltage is divided by a voltage divider circuit into a gamma compensated voltage for each grayscale. The gamma compensated voltage for each grayscale is provided to the DAC in the data driver 110. The data voltage may be output through an output buffer in each of the channels of the data driver 110 and supplied to the data lines 102.

The sensing channels of the data driver 110 include an analog to digital converter (hereinafter referred to as “ADC”). The sensing channels convert a sensing voltage received from a sub-pixel through the sensing lines 104 into digital data using the ADC to output sensing data Dsen. The sensing data Dsen is sent to the timing controller 130.

The gate driver 120 may be disposed in at least one of left and right non-display areas BZ of the display panel 100 outside the display area AA, or at least a portion thereof may be disposed within the display area AA. The gate driver 120 may be arranged in a non-display areas BZ on both side of the display panel 100 across the display area AA of the display panel, so that pulses of gate signals may be supplied from both sides of the gate lines 103 in a double feeding manner. In another embodiment, the gate driver 120 may be arranged in at least one side of the left and right non-display areas BZ of the display panel 100 to supply gate signals to the gate lines 103 in a single feeding method. The gate driver 120 sequentially outputs pulses of the gate signals to the gate lines 103 under the control of the timing controller 130. The gate driver 120 may sequentially supply the pulses of the gate signal to the gate lines 103 by shifting the pulses of the gate signal using a shift register.

A host system 200 may scale an image signal from a video source to match the resolution of the display panel 100, and may transmit it to the timing controller 130 together with the timing signal. The timing controller 130 receives from the host system 200 digital video data of the input image and timing signals synchronized with this data. The timing signal may include a vertical synchronization signal Vsync, a horizontal synchronization signal Hsync, and a data enable signal DE. Because a vertical period and a horizontal period may be known by counting the data enable signal DE, the vertical synchronization signal Vsync and the horizontal synchronization signal Hsync may be omitted. The horizontal synchronization signal Hsync and the data enable signal DE have a period of one horizontal period (1H).

The timing controller 130 may control the operation timing of each of the data driver 110 and the gate driver 120 based on the timing signals Vsync, Hsync, and DE received from the host system 200. The timing controller 130 generates a data timing control signal for controlling the operation timing of the data driver 110 and a gate timing control signal for controlling the operation timing of the gate driver 120. The level shifter, not shown in the drawing may shift the voltage level of the gate timing control signal and transmit it to the gate driver 120.

The display device according to an embodiment of the present disclosure further includes a memory 300 accessed by the timing controller 130.

The timing controller 130 may include a logic circuit that compensates for the deterioration of each of the sub-pixels by modulating the pixel data of the input image as compensation data for compensating for the deterioration of each of the sub-pixels. The compensation data may include first compensation data for predicting deterioration based on stress data accumulated pixel data for each sub-pixel, and second compensation data obtained in real time based on the sensing data Dsen received through the sensing line 104. The compensation data may compensate for degradation of at least one of a driving transistor M1 and a light emitting element EL of the pixel circuit shown in FIG. 2. The first compensation data may be, but is not limited to, the compensation data or gains disclosed by the applicant of the present application, in Korean Registered Patent No. 10-1960795 (Mar. 15, 2019), Korean Registered Patent No. 10-1983764 (May 23, 2019), Korean Registered Patent No. 10-2618389 (Dec. 21, 2023) and the like.

The compensation data may be stored in the memory 300 under the control of the timing controller 130. The memory 300 may include a non-volatile memory and a volatile memory. The non-volatile memory may include one or more of, for example, a not AND (NAND) flash memory, a not OR (NOR) flash memory, and an electrically erasable programmable read-only memory (EPROM). The NAND flash memory may be a single level cell (SLC) type. The volatile memory may include one or more of a dynamic RAM (DRAM), a static RAM (SRAM), a synchronous dynamic RAM (SDR), and a double data rate SDRAM (DDR SDRAM).

The timing controller 130 may accumulate pixel data for each sub-pixel in each frame period to calculate stress data, and may update the stress data by overwriting the stress data in a non-volatile memory at a predetermined time interval, for example, at 30 minute intervals.

The timing controller 130 may add or multiply the compensation data to the pixel data DATA of an input image to output a modulated pixel data DATA′. The modulated pixel data DATA′ is transmitted to the data driver 110.

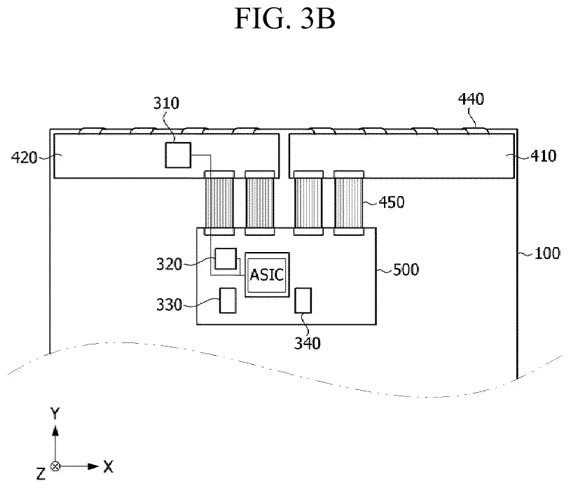

The timing controller 130 may be implemented with an application-specific integrated circuit (ASIC). The data driver 110 may be implemented with the source drive IC (SIC) shown in FIG. 3A.

FIG. 2 is a circuit diagram showing a pixel circuit according to one embodiment of the present disclosure.

Referring to FIG. 2, the pixel circuit may include a light-emitting element EL, a driving transistor M1, a storage capacitor Cst, a first switching transistor M2, and a second switching transistor M3.

The light emitting element EL may be an organic light emitting diode (hereinafter referred to as “OLED”). The OLED includes an anode electrode, a cathode electrode, and an organic compound layer arranged between these electrodes. The organic compound layer includes a light-emitting layer. When a voltage is applied to the anode and cathode electrodes of the light emitting element EL, holes passing through the hole transport layer (HTL) and electrons passing through the electron transport layer (ETL) move to the emission layer (EML) to form excitons. In this case, visible light is emitted from the emission layer (EML). The light emitting element EL may be implemented as a tandem structure with a plurality of light emitting layers stacked on top of each other. The light emitting element EL having the tandem structure may improve the luminance and lifetime of the pixels.

The driving transistor M1 drives the light emitting element EL by generating a current flowing to the light emitting element EL according to a gate-source voltage. The driving transistor M1 includes a first electrode to which a pixel driving voltage EVDD is applied, a gate electrode connected to a first node n1, and a second electrode connected to a second node n2. The storage capacitor Cst is connected between the first node n1 and the second node n2 to maintain the gate-source voltage of the driving transistor M1.

The first switching transistor M2 supplies a data voltage Vdata to the first node n1 in response to a first gate pulse SCAN. The first switch transistor M2 includes a first electrode connected to a data line 102 to which a data voltage Vdata is applied, a gate electrode connected to a gate line 103 to which a first gate pulse SCAN is applied, and a second electrode connected to the second node n2.

The second switching transistor M3 connects the second node n2 to the sensing line 104 in response to a second gate pulse SENSE. The second switch transistor M3 includes a first electrode connected to the second node n2, a gate electrode connected to the gate line to which the second gate pulse SENSE is applied, and a second electrode connected to the sensing line 104. A predetermined reference voltage may be applied to the sensing line 104.

FIGS. 3A and 3B are diagrams illustrating connection structures of circuit boards of a display device according to one embodiment of the present disclosure. FIG. 3A is a front view of the display panel 100. FIG. 3B is a rear view of the display panel 100 in a state in which source PCBs (source boards) and a control PCB (a control board) are folded to the rear surface of the display panel 100.

Referring to FIGS. 3A and 3B, source PCBs 410 and 420 may be electrically connected to the display panel 100. A control PCB 500 may be electrically connected to the source PCBs 410 and 420 through a flexible cable, for example, at least one a flexible flat cable (FFC) 450.

A source drive IC SIC may be mounted on a flexible film of a chip on film (COF) 440 to be connected between the source PCBs 410 and 420 (and the display panel 100 in the COF bonding process. In FIGS. 3A and 3B, the source PCBs 410 and 420 are illustrated as two PCBs, but is not limited thereto.

A first non-volatile memory 310 may be arranged on at least one of the source PCBs 410 and 420. The timing controller 130 and a second non-volatile memory 320 may be arranged on the control PCB 500.

One or more volatile memories 330 and 340 may be arranged on the control PCB 500. The first volatile memory 330 may store compensation data and pixel driving timing data, and the second volatile memory 340 may be used as a frame memory in which an amount of pixel data of one frame may be stored, but is not limited thereto. For example, the timing controller 130 may be connected to one volatile memory. The pixel driving timing data may include setting values related to the rising timing of the gate pulses SCAN and SENSE, a pulse width or pulse duration, and the like, but is not limited thereto.

A power circuit not shown in the drawing, for example, a power management IC (PMIC) may be located on the control PCB 500. The PMIC outputs a constant voltage (or direct current voltage) required to drive the pixels of the display panel 100, such as an IC driving voltage Vcc, a pixel driving voltage EVDD, a cathode voltage EVSS, a gate high voltage, a gate low voltage, and a gamma reference voltage.

The control PCB 500 may be connected to the source PCB 410 and 420 through the FFC 450. The source PCBs 410 and 420 and the control PCB 500 connected to the display panel 100 may be faced to the rear surface of the display panel 100 by the COF 440 curved as shown in FIG. 3B.

Based on the sensing results for each sub-pixel of the display panel 100, unique initial compensation data may be set for each display panel. In an embodiment of the present disclosure, the initial compensation data set to a unique value for each display panel is stored in the first non-volatile memory 310 mounted on a source PCB 410 connected to the display panel 100. In this case, since the first non-volatile memory 310 in which the initial compensation data is stored is transferred during the process as a set with the display panel 100, a 1:1 matching of the control PCB 500 and the display panel 100 is not required.

Meanwhile, when the initial compensation data is stored in the second non-volatile memory 320 mounted on the control PCB 500, since the process is to be carried out by a 1:1 matching of the display panel 100 and the control PCB 500, a matching operation is required to attach a bar code label on which a serial number of the display panel is recorded to the display panel 100 and the control PCB 500 matched on a 1:1 basis. In contrast, the present disclosure does not require the 1:1 match between the control PCB 500 and the display panel 100 because the initial compensation data is stored in the first non-volatile memory.

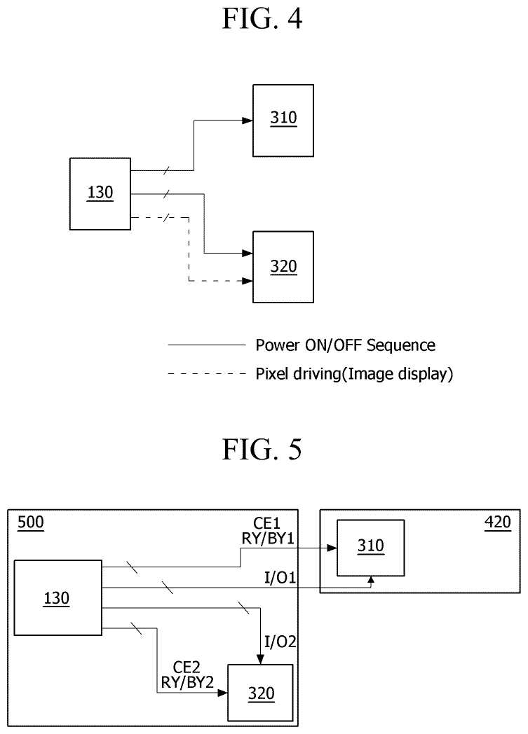

FIG. 4 is a diagram schematically showing a connection structure of a timing controller and first and second non-volatile memories.

Referring to FIG. 4, the timing controller 130 is connected to the first non-volatile memory 310 and the second non-volatile memory 320. In addition, the timing controller 130 is connected to the volatile memories 330 and 340.

The timing controller 130 may access the first non-volatile memory 310 and the second non-volatile memory 320 in a power-on sequence to transfer data stored in the first non-volatile memory 310 to the second non-volatile memory 320 and store the data in the second non-volatile memory 320. Herein, the data may include, but is not limited to, compensation data and pixel driving timing data.

The timing controller 130 may access the first non-volatile memory 310 or the second non-volatile memory 320 in a power-off sequence and store data stored in the volatile memory in the first non-volatile memory 310 or the second non-volatile memory 320.

The timing controller 130 may drive pixels and compensate for deterioration of pixels in real time while accessing the second non-volatile memory 320 and the volatile memories 330 and 340, during a pixel driving period. During the pixel driving period, the timing controller 130 may compensate for the deterioration of pixels in real time by modulating pixel data with compensation data and transmitting it to the source drive IC SIC. The input image may be displayed on the display area AA of the display panel 100 during the pixel driving period.

The power-on sequence includes a series of processes in which a power-on signal is input to the display device and the power circuit and the display panel driving circuit are started to be operated in a preset sequence. During the power-on sequence, the pixels are not driven because the timing controller 130 does not send valid pixel data to the source drive IC SIC. The power-off sequence includes a series of processes in which a power-off signal is input to the display device the power circuit and the display panel driving circuit are powered off in a preset sequence to stop the driving. During the power-off sequence, the pixels are not driven because the timing controller 130 does not send valid pixel data to the source drive IC SIC. During the power-on sequence and power-off sequence, the input image may not be displayed on the display panel 100 and the pixels may appear black.

The timing controller 130 may deactivate the second non-volatile memory 320 during at least a partial time of the power-on sequence and the power-off sequence, and to deactivate the first non-volatile memory 310 during the pixel driving period.

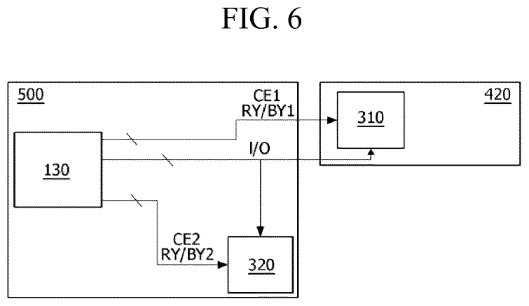

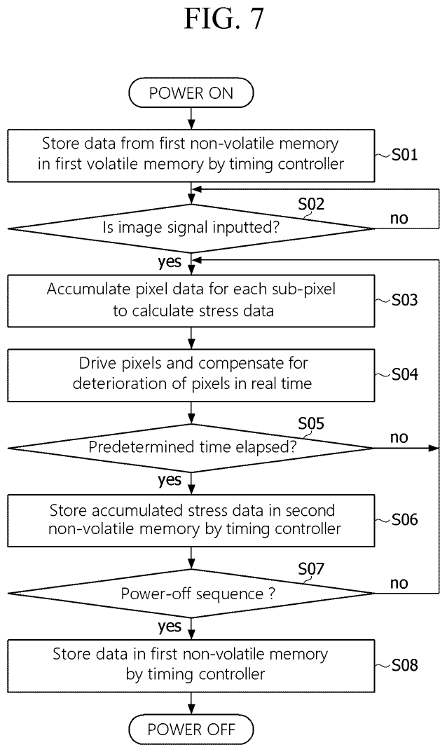

FIGS. 5 and 6 are diagrams schematically showing connection structures of a timing controller and first and second non-volatile memories when the non-volatile memory is an SLC type NAND flash memory.

Referring to FIGS. 5 and 6, the timing controller 130 may be connected to the first and second non-volatile memories 310 and 320 through chip enable signal lines through which data is transmitted and input/output lines I/O through which data is transmitted. Each of the chip enable signal lines CE1 RY/BY1 and CE2 RY/BY2 may be two wires connected to two pins. Each of the input/output lines I/O may include 21 wires connected to 21 pins.

The timing controller 130 may be connected to the first non-volatile memory 310 through the first chip enable signal lines CE1 RY/BY1 and the first input/output lines I/O1, and may be connected to the second non-volatile memory 320 through the second chip enable signal lines CE2 RY/BY2 and the second input/output lines I/O2, as illustrated in FIG. 5.

The timing controller 130 may drive the first non-volatile memory 310 through the first chip enable signal lines CE1 RY/BY1 to read, write, and erase data in the first non-volatile memory 310. The timing controller 130 may drive the second non-volatile memory 320 through the second chip enable signal lines CE2 RY/BY2 to read, write, and erase data in the second non-volatile memory 320.

The first non-volatile memory 310 is driven and accessed by the timing controller 130 when the first chip enable signal line CE1 RY/BY1 is at an active logic value. In this case, the first non-volatile memory 310 may be read, written and erased. Since the first non-volatile memory 310 is not driven when the first chip enable signal line CE1 RY/BY1 is at an inactive logic value, it is not accessed by the timing controller 130 and little current consumption is generated.

The second non-volatile memory 320 is driven and accessed by the timing controller 130 when the second chip enable signal line CE2 RY/BY2 is at an active logic value. In this case, the second non-volatile memory 320 may be read, written, and erased. Since the second non-volatile memory 320 is not driven when the second chip enable signal line CE2 RY/BY2 is at an inactive logic value, it is not accessed and little current consumption is generated by the timing controller 130.

The active logic value of the chip enable signals CE1 RY/BY1 and CE2 RY/BY2 may be 0 (zero) (or LOW), and the inactive logic value may be 1 (or HIGH), but is not limited thereto.

During a pixel driving period in which an input image is displayed on the display panel 100, the timing controller 130 may set the first chip enable signal line CE1 RY/BY1 as an inactive logic value, for example, 1 (or HIGH), while setting the second chip enable signal line CE2 RY/BY1 as an active logic value, for example, 0 (zero) (or LOW). In this case, during the pixel driving period, since signals are not transmitted between the timing controller 130 and the first non-volatile memory 310, the EMI is not generated in the FFC 450 between the control PCB 500 and the source PCB 410 and 420.

The timing controller 130 may reduce current consumption by deactivating a memory that is not accessed among the first and second non-volatile memories 310 and 320, but is not limited thereto. For example, during a power-on/off period in which pixels are not driven, the timing controller 130 may access the first non-volatile memory 310 by setting the first chip enable signal CE1 RY/BY1 line as an active logic value, while it may control the second non-volatile memory 320 to be turned off by settling the second chip enable signal CE2 RY/BY2 line as an inactive logic value. During a pixel driving period in which pixels are driven, the timing controller 130 may access the second non-volatile memory 320 by setting the second chip enable signal CE2 RY/BY2 as an active logic value, while it may control the first non-volatile memory 310 to be turned off by setting the first chip enable signal CE1 RY/BY1 as an inactive logic value.

The timing controller 130 may control one of the non-volatile memories 310 and 320 to be turned off through the chip enable signal lines CE1 RY/BY1 and CE2 RY/BY2. Accordingly, the first and second non-volatile memories 310 and 320 connected to the timing controller 130 have chip enable signal lines CE1 RY/BY1 and CE2 RY/BY2 separated for each IC, while the input/output signal I/O lines are shared, so that the number of signal lines may be reduced by nearly half.

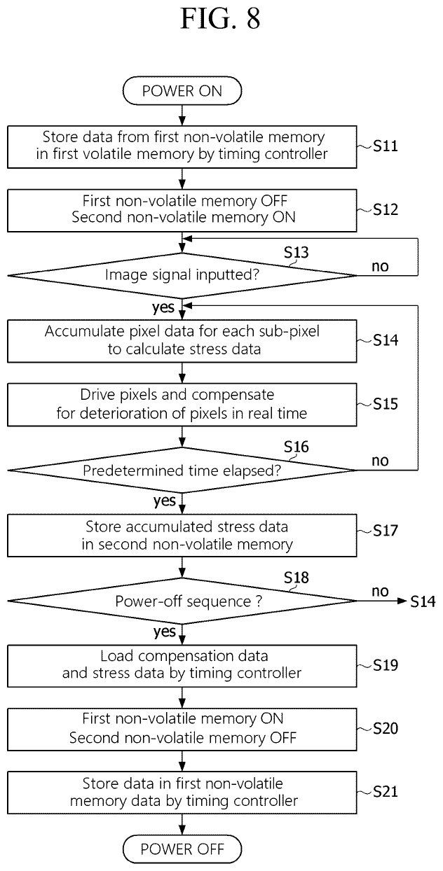

FIG. 7 is a flow diagram illustrating a memory access method according to a first embodiment of the present disclosure.

Referring to FIG. 7, a power-on sequence may be started when a power-on signal is input to the host system 200. In the power-on sequence, when an IC drive power is input from a power circuit to the timing controller 130, the timing controller 130 is driven to access the first non-volatile memory 310 to load data stored in the first non-volatile memory 310 into the first volatile memory 330. Herein, the data may include the compensation data, the pixel driving timing data, and stress data. In this case, the data from the first non-volatile memory 310 is stored in the first volatile memory 330 (S01).

After the power-on sequence, when an image signal is input to the timing controller 130, a pixel driving period is started (S02). During the pixel driving period, the timing controller 130 accumulates pixel data of the input image for each sub-pixel to calculate stress data (S03). The timing controller 130 may predict the deterioration of each of the sub-pixels based on the stress data accumulated for each sub-pixel. The timing controller 130 may store the compensation data calculated based on the stress data in the first volatile memory 330 during the pixel driving period. The timing controller 130 transmits the pixel data to the source drive IC SIC to drive the pixels, and modulates the pixel data based on the compensation data read by accessing the first volatile memory 330 to compensate for the deterioration of the pixels in real time (S04). The timing controller 130 may temporarily store the pixel data in the second volatile memory 340 to modulate the pixel data based on the compensation data, during the pixel driving period.

The timing controller 130 may count the pixel driving period to store the accumulated stress data in the second non-volatile memory 320 at a predetermined time interval, for example, at 30-minute intervals (S05 and S06). The timing controller 130 accesses the memories 320, 330, and 340 on the control PCB 500, but does not access the memory 310 on the source PCBs 410 and 420, during the pixel driving period. Accordingly, the EMI is not generated in the signal transmission path between the timing controller 130 and the first non-volatile memory 310 and little current consumption is generated in the first non-volatile memory 310, during the pixel driving period.

A power-off sequence may be started when a power-off signal is input to the host system 200 (S07). When the power-off sequence is started, the timing controller 130 accesses the first volatile memory 330 and the second non-volatile memory 320 and loads the compensation data and the stress data into the first non-volatile memory 310 to store the compensation data and the stress data in the first non-volatile memory 310 before the power output from the power circuit is cut off (S08). After the display device is powered off, the compensation data and the stress data stored in the first non-volatile memory 310 are not erased and are loaded into the second non-volatile memory 320 in a next power-on sequence.

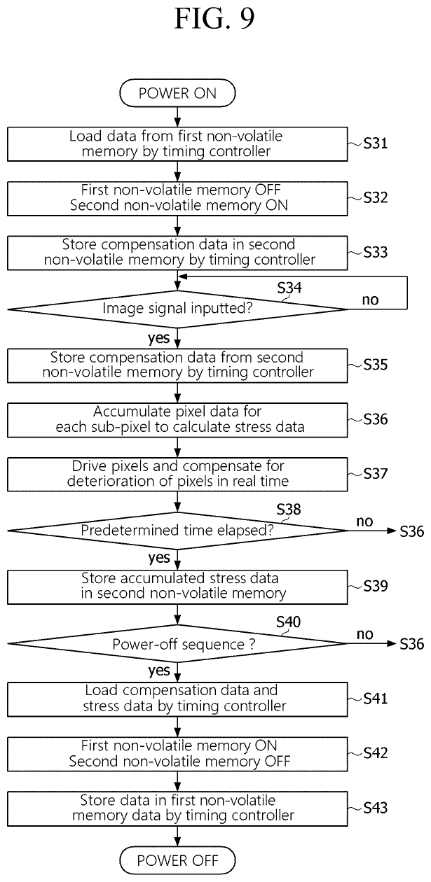

FIG. 8 is a flowchart illustrating a memory access method according to a second embodiment of the present disclosure.

Referring to FIG. 8, the timing controller 130 may store the data stored in the first non-volatile memory 310 in the first volatile memory 330 in the power-on sequence, and then deactivate (OFF) the first non-volatile memory 310 and activate (ON) the second non-volatile memory 320 (S11 and S12). Herein, the data may include the compensation data, the pixel driving timing data, and stress data.

During the pixel driving period, the timing controller 130 accumulates pixel data of the input image for each sub-pixel to calculate the stress data (S13 and S14). The timing controller 130 may store the compensation data calculated based on the stress data in the first volatile memory 330 during the pixel driving period. The timing controller 130 transmits the pixel data to the source drive IC SIC to drive the pixels, and modulates the pixel data based on the compensation data read by accessing the first volatile memory 330 to compensate for the deterioration of the pixels in real time, during the pixel driving period (S15). The timing controller 130 may temporarily store the pixel data in the second volatile memory 340 to modulate the pixel data based on the compensation data, during the pixel driving period.

The timing controller 130 may count the pixel driving period to store the accumulated stress data in the second non-volatile memory 320 at a predetermined time interval, for example, at 30-minute intervals (S16 and S17). Since the EMI is not generated in the signal transmission path between the timing controller 130 and the first non-volatile memory 310 during the pixel driving period, little current consumption is generated in the first non-volatile memory 310.

When the power-off sequence is started (S18), the timing controller 130 accesses the first volatile memory 330 and the second non-volatile memory 320 to load the compensation data and the stress data (S19), and then activates (ON) the first non-volatile memory 310 and deactivates (OFF) the second non-volatile memory 320 (S20). Subsequently, the timing controller 130 stores the compensation data and the stress data in the first non-volatile memory 310 before the display device is powered off (S21).

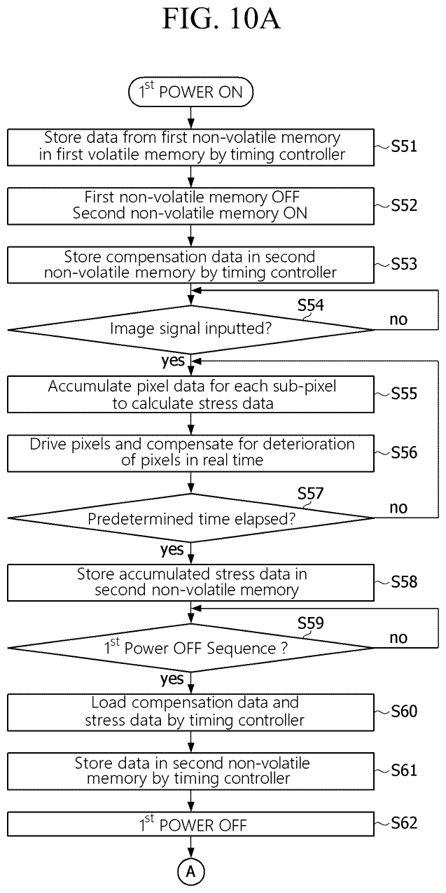

FIG. 9 is a flowchart illustrating a memory access method according to a third embodiment of the present disclosure.

Referring to FIG. 9, the timing controller 130 may load the data stored in the first non-volatile memory 310 in the power-on sequence, and then deactivate (OFF) the first non-volatile memory 310 and activate (ON) the second non-volatile memory 320 (S31 and S32). Herein, the data may include the compensation data, the pixel driving timing data, and stress data. Subsequently, the timing controller 130 stores the data loaded from the first non-volatile memory 310 in the power-off sequence in the second non-volatile memory 320 (S33).

When the pixel driving period is started, the timing controller 130 stores the compensation data stored in the second non-volatile memory 320 in the first volatile memory 330 (S34 and S35). The timing controller 130 accumulates the pixel data of the input image for each sub-pixel to calculate the stress data, during the pixel driving period (S36). The timing controller 130 may store the compensation data calculated based on the stress data in the first volatile memory 330 during the pixel driving period. The timing controller 130 transmits the pixel data to the source drive IC SIC to drive the pixels, and modulates the pixel data based on the compensation data read by accessing the first volatile memory 330 to compensate for the deterioration of the pixels in real time, during the pixel driving period (S37). The timing controller 130 may temporarily store the pixel data in the second volatile memory 340 to modulate the pixel data based on the compensation data, during the pixel driving period.

The timing controller 130 may count the pixel driving period to store the accumulated stress data in the second non-volatile memory 320 at a predetermined time interval, for example, at 30-minute intervals (S38 and S39). Since the EMI is not generated in the signal transmission path between the timing controller 130 and the first non-volatile memory 310, little current consumption is generated in the first non-volatile memory 310, during the pixel driving period.

When the power-off sequence is started (S40), the timing controller 130 accesses the first volatile memory 330 and the second non-volatile memory 320 to load the compensation data and the stress data (S41), and then activates (ON) the first non-volatile memory 310 and deactivates (OFF) the second non-volatile memory 320 (S42). Subsequently, the timing controller 130 stores the compensation data and the stress data in the first non-volatile memory 310 before the display device is powered off (S43).

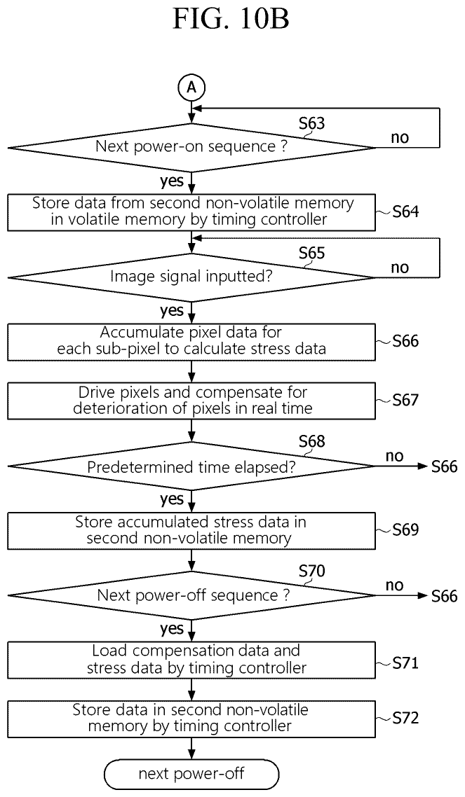

FIGS. 10A and 10B are flowcharts illustrating a memory access method according to a fourth embodiment of the present disclosure. The flow chart shown in FIG. 10A and the flow chart shown in FIG. 10B are connected at ‘A’.

Referring to FIG. 10A, the timing controller 130 may load the data stored in the first non-volatile memory 310 in a first power-on sequence, and then deactivate (OFF) the first non-volatile memory 310 and activate (ON) the second non-volatile memory 320 (S51 and S52). Herein, the data may include the compensation data, the pixel driving timing data, and stress data. Subsequently, the timing controller 130 stores the data loaded from the first non-volatile memory 310 in the power-off sequence in the second non-volatile memory 320 (S53).

During the first pixel driving period after the first power-on sequence, the timing controller 130 stores compensation data stored in the second non-volatile memory 320 in the first volatile memory 330 and accumulates pixel data of the input image by sub-pixel to calculate stress data (S54 and S55). The timing controller 130 may store compensation data calculated based on the stress data in the first volatile memory 330 during the first pixel driving period. The timing controller 130 drives pixels by transmitting the pixel data to the source drive IC SIC during the first pixel driving period, and modulates the pixel data based on the compensation data read by accessing the first volatile memory 330 to compensate for deterioration of the pixels in real time (S56). The timing controller 130 may temporarily store the pixel data in the second volatile memory 340 and modulate the pixel data based on the compensation data, during the first pixel driving period.

The timing controller 130 may count the first pixel driving period and store the accumulated stress data in the second non-volatile memory 320 at predetermined time intervals, for example, 30 minutes (S57 and S58). During the first pixel driving period, signals are not transmitted in the signal transmission path between the timing controller 130 and the first non-volatile memory 310, so the EMI is not generated and little current consumption is generated in the first non-volatile memory 310.

When the first power-off sequence is started after the first pixel driving period (S59), the timing controller 130 loads the compensation data from the first volatile memory 330 into the second non-volatile memory 320 and stores it in the second non-volatile memory 320 (S60, and S61). After the compensation data is stored in the second non-volatile memory 320 by the timing controller 130, the power circuit stops the driving and the display device is powered off (S62).

Referring to FIG. 10B, the timing controller 130 loads data stored in the second non-volatile memory 320 into the first volatile memory 330 in a second power-on sequence and stores it in the first volatile memory 330 (S63 and S64). The second power-on sequence is the next power-on sequence following the first power-on sequence.

During the second pixel driving period after the second power-on sequence, the timing controller 130 accumulates pixel data of the input image for each sub-pixel to calculate the stress data (S65 and S66). The timing controller 130 stores compensation data calculated based on the stress data in the first volatile memory 330 during the second pixel driving period, transmits the pixel data to the source drive IC SIC to drive the pixels, and modulates the pixel data based on the compensation data read by accessing the first volatile memory 330 to compensate for deterioration of the pixels in real time (S67). The timing controller 130 may temporarily store the pixel data in the second volatile memory 340 and modulate the pixel data based on the compensation data, during the second pixel driving period. The second pixel driving period is the pixel driving period following the second power-on sequence.

The timing controller 130 may count the second pixel driving period and store the accumulated stress data in the second non-volatile memory 320 at predetermined time intervals, for example, 30 minutes (S68 and S69). During the second pixel driving period, signals are transmitted in the signal transmission path between the timing controller 130 and the first non-volatile memory 310, so the EMI is not generated and little current consumption is generated in the first non-volatile memory 310.

When the second power-off sequence is started after the second pixel driving period (S70), the timing controller 130 loads compensation data from the first volatile memory 330 into the second non-volatile memory 320 and stores it in the second non-volatile memory 320 (S71 and S72). After the compensation data is stored in the second non-volatile memory 320 by the timing controller 130, the power circuit stops the driving and the display device is powered off.

According to one or more embodiments of the present disclosure, the display device may be applied to mobile apparatuses, video phones, smart watches, watch phones, wearable apparatus, foldable apparatus, rollable apparatus, bendable apparatus, flexible apparatus, curved apparatus, sliding apparatus, variable apparatus, electronic organizer, electronic books, portable multimedia players (PMPs), personal digital assistants (PDAs), MP3 players, mobile medical apparatuses, desktop PCs, laptop PCs, netbook computers, workstations, navigations, vehicle navigations, vehicle display apparatuses, vehicle apparatuses, theater apparatuses, theater display apparatuses, televisions, wallpaper apparatuses, signage apparatuses, game apparatuses, laptops, monitors, cameras, camcorders, and home appliances, etc. Additionally, the display apparatus according to one or more embodiments of the present disclosure may be applied to organic light emitting lighting apparatuses or inorganic light emitting lighting apparatuses.

The aspects to be achieved by the present disclosure, the means for achieving the aspects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A display device, comprising:
a display panel in which a plurality of data lines and a plurality of pixels are arranged;
a source board including a first non-volatile memory and electrically connected to the display panel; and
a control board including a timing controller, a second non-volatile memory, and one or more volatile memories and electrically connected to the source board.

2. The display device of claim 1, wherein the timing controller is configured to access the first non-volatile memory during a power-on sequence and a power-off sequence of the display device, and to access the second non-volatile memory during a pixel driving period in which an image is displayed on the display panel.

3. The display device of claim 1, further comprising:
at least one flexible cable electrically connecting the source board and the control board.

4. The display device of claim 2, wherein the timing controller is configured to load data stored in the first non-volatile memory into the one or more volatile memories during the power-on sequence of the display device, and to load the data stored in the one or more volatile memories into the first non-volatile memory during the power-off sequence of the display device.

5. The display device of claim 2, wherein during the pixel driving period, the timing controller is configured to accumulate pixel data for each sub-pixel, to modulate the pixel data using data read from the one or more volatile memories, and to store stress data in which the pixel data is accumulated for each sub-pixel in the second non-volatile memory at predetermined time intervals.

6. The display device of claim 1, wherein the timing controller is connected to the first non-volatile memory through first chip enable signal lines and first input/output signal lines, and is connected to the second non-volatile memory through second chip enable signal lines and second input/output signal lines.

7. The display device of claim 1, wherein the timing controller is connected to the first non-volatile memory through first chip enable signal lines and input/output signal lines, and is connected to the second non-volatile memory through second chip enable signal lines and input/output signal lines.

8. The display device of claim 2, wherein the timing controller is configured to deactivate the second non-volatile memory during at least a partial time of the power-on sequence and the power-off sequence, and to deactivate the first non-volatile memory during the pixel driving period.

9. The display device of claim 1, each of the first non-volatile memory and the second non-volatile memory includes one or more of a NAND flash memory, a NOR flash memory, and an electrically erasable programmable read-only memory (EEPROM).

10. A memory access method of a display device, which comprises a source board including a first non-volatile memory and electrically connected to a display panel, and a control board including a timing controller, a second non-volatile memory, and one or more volatile memories, the memory access method comprising:
loading, in a power-on sequence of the display device, data from the first non-volatile memory into the one or more volatile memories by the timing controller;
storing, during a pixel driving period in which an image is displayed on the display panel, stress data in which pixel data is accumulated in the second non-volatile memory at predetermined time intervals; and
storing, in a power-off sequence of the display device, compensation data stored in the one or more volatile memories and the stress data stored in the second non-volatile memory, in the first non-volatile memory by the timing controller.

11. The memory access method of claim 10, further comprising:
deactivating the first non-volatile memory and activating the second non-volatile memory by the timing controller, after loading, in the power-on sequence, the data from the first non-volatile memory into the one or more volatile memories; and
activating, in the power-off sequence, the first non-volatile memory and deactivating the second non-volatile memory by the timing controller, before the compensation data and the stress data are stored in the first non-volatile memory.

12. A memory access method of a display device, which comprises a source board including a first non-volatile memory and electrically connected to a display panel, and a control board including a timing controller, a second non-volatile memory, and one or more volatile memories, the memory access method comprising:
loading, in a power-on sequence of the display device, data from the first non-volatile memory into the second non-volatile memory by the timing controller;
during a pixel driving period in which an image is displayed on the display panel, loading data stored in the second non-volatile memory into the one or more volatile memories by the timing controller and storing data in which pixel data is accumulated in the second non-volatile memory at predetermined time intervals; and
storing, in a power-off sequence of the display device, compensation data stored in the one or more volatile memories and stress data stored in the second non-volatile memory, in the first non-volatile memory by the timing controller.

13. The memory access method of claim 12, further comprising:
in the power-on sequence, deactivating the first non-volatile memory and activating the second non-volatile memory by the timing controller after the timing controller loads the data from the first non-volatile memory; and
in the power-off sequence, activating the first non-volatile memory and deactivating the second non-volatile memory by the timing controller before the compensation data and the stress data are stored in the first non-volatile memory.
